(19) United States
(12) Patent Application Publication
(10) Pub. No.: US 2007/0275855 A1
(43) Pub. Date: Nov. 29, 2007

(54) Herbicidal Composition

(75) Inventors: Hiroshi Kikugawa, Kusatsu-shi (JP); Ken Ohno, Kusatsu-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ISHIHARA SANGYO KAISHA, LTD., Osaka-shi (JP)

(21) Appl. No.: 11/574,891

(22) PCT Filed: Sep. 16, 2005
(86) PCT No.: PCT/JP05/17185

§ 371 Date: Mar. 8, 2007

(30) Foreign Application Priority Data
Sep. 17, 2004 (JP) 2004-271282
Mar. 2, 2005 (JP) 2005-057621

(51) Int. Cl. A01N 43/54

(52) U.S. Cl. 504/136

(57) ABSTRACT

To provide a herbicidal composition which has a wider herbicidal spectrum and which is highly active and has a long lasting effect.
A herbicidal composition comprising (1) a compound of the following formula (I) or its salt: 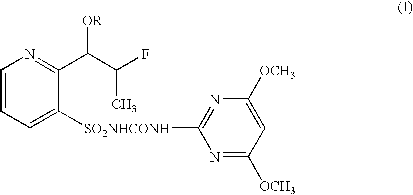
wherein R is a hydrogen atom or —COCH₂OCH₃, and (2) 2-chloro-3-[2-chloro-5-(4-difluoromethyl-4,5-dihydro-3-methyl-5-oxo-1H-1,2,4-triazol-1-yl)-4-fluorophenyl]propionic acid, its salt or its alkyl ester, as active ingredients.

### TECHNICAL FIELD

The present invention relates to a herbicidal composition comprising (1) a compound of the after-mentioned formula (I) or its salt, and (2) 2-chloro-3-[2-chloro-5-(4-difluoromethyl-4,5-dihydro-3-methyl-5-oxo-1H-1,2,4-triazol-1-yl)-4-fluorophenyl]propionic acid (simply referred to as compound B), its salt or its alkyl ester, as active ingredients.

### BACKGROUND ART

WO02/30921 or WO92/14728 discloses a compound of the after-mentioned formula (I), but fails to disclose to mix it with compound B.

Patent Document 1 WO 02/30921

Patent Document 2 WO 92/14728

### DISCLOSURE OF THE INVENTION

Problems to be Solved by the Invention

Many herbicidal compositions have been developed and practically used. However types of weeds to be controlled are also many and their emergence extends over a long period. Accordingly, it is desired that a herbicidal composition be developed which has a wider herbicidal spectrum and which is highly active and has a long lasting effect.

Means to Solve the Problems

The present inventors have conducted a research to solve the above problems and as a result, have found it possible to obtain a herbicidal composition having a high practical applicability by mixing a compound of the after-mentioned formula (I) or its salt, and compound B, its salt or its alkyl ester, and the present invention has been accomplished on the basis of such a discovery.

Thus, the present invention provides a herbicidal composition comprising (1) a compound of the following formula (I) or its salt: 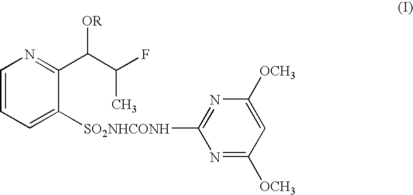
wherein R is a hydrogen atom or —OCH₂OCH₃, and (2) 2-chloro-3-[2-chloro-5-(4-difluoromethyl-4,5-dihydro-3-methyl-5-oxo-1H-1,2,4-triazol-1-yl)-4-fluorophenyl]propionic acid, its salt or its alkyl ester, as active ingredients such a herbicidal composition which further contains another herbicidally active ingredient, and a method for controlling undesired plants or inhibiting their growth, which comprises applying a herbicidally effective amount of such a herbicidal composition.

### EFFECTS OF THE INVENTION

The herbicidal composition of the present invention, i.e. the herbicidal composition comprising the compound of the formula (I) or its salt, and the compound B, its salt or its alkyl ester, as active ingredients, is capable of controlling a wide range of weeds emerging in cropland or non-cropland, and it surprisingly presents a synergistic herbicidal effect i.e. a herbicidal effect higher than the mere addition of the respective herbicidal effects of the active ingredients. With such a herbicidal composition of the present invention, not only it can be applied at a low dose as compared with a case where the respective active ingredients are applied individually, but also the herbicidal spectrum will be enlarged, and further the herbicidal effects will last over a long period of time.

When the herbicidal activity in a case where two active ingredients are combined, is larger than the simple sum of the respective herbicidal activities of the two active ingredients (the expected activity), it is called a synergistic effect. The activity expected by the combination of two active ingredients can be calculated as follows (Colby S. R., “Weed”, vol. 15, p. 20-22, 1967).
E=α+β−(α×β÷100)
where α: growth inhibition rate when treated with x (g/a) of herbicide X,

β: growth inhibition rate when treated with y (g/a) of herbicide Y,

E: growth inhibition rate expected when treated with x (g/a) of herbicide X and y (g/a) of herbicide Y.

Namely when the actual growth inhibition rate (observed value) is larger than the growth inhibition rate by the above calculation (expected value), the activity by the combination can be regarded as showing a synergistic effect. The herbicidal composition of the is present invention shows a synergistic effect when calculated by the above formula.

Best Mode for Carrying out the Invention

The compound of the formula (I) has two asymmetric carbon atoms and thus has an isomer such as erythro or threo. Accordingly, the compound of the formula (I) in the present invention includes each of such isomers and a mixture of such isomers.

The salt of the compound of the formula (I) may be any salt so long as it is agriculturally acceptable, and it may, for example, be an alkali metal salt such as a sodium salt or a potassium salt; an alkaline earth metal salt such as a magnesium salt or a calcium salt; an ammonium salt such as a dimethylammonium salt or a triethylammonium salt; an inorganic acid salt such as a hydrochloride, a perchlorate, a sulfate or a nitrate; or an organic acid salt such as an acetate or a methanesulfonate.

Compounds of the formula (I), i.e. a compound wherein substituent R is a hydrogen atom (simply referred to as compound A1) and a compound wherein R is —COCH₂OCH₃ (simply referred to as compound A2) both show preferred effects in the present invention. Among them, the compound A2 wherein R is —COCH₂OCH₃ (common name: flucetosulfuron) is more preferred in the present invention.

Compound B has asymmetric carbon atom and thus has optical isomers, and in the present invention, it includes each of such isomers and a mixture of such isomers.

The salt of compound B may be any salt so long as it is agriculturally acceptable and may, for example, be the same salt as the above-mentioned salt of the compound of the formula (I).

The alkyl ester of compound B may be any alkyl ester so long as it is agriculturally acceptable and may, for example, be a C₁₋₆ linear or branched ester such as methyl, ethyl, propyl, isopropyl, butyl, tert-butyl, pentyl or hexyl. Among these alkyl esters, preferred is ethyl ester (common name: carfentrazone-ethyl, simply referred to as compound B1).

The mix ratio of the compound of the formula (I) or its salt, and compound B, its salt or its alkyl ester, as active ingredients in the herbicidal composition of the present invention can not generally be defined since it varies depending upon various conditions such as the formulations weather conditions, the types and growth conditions of the plants to be controlled. However, usually, the amount of compound B, its salt or its alkyl ester is from 0.01 to 50 parts by weight, preferably from 0.5 to 25 parts by weight, per part by weight of the compound of the formula (I) or its salt.

Further, the present invention includes a herbicidal composition which contains, in addition to the compound of the formula (I) or its salt and compound B, its salt or its alkyl ester, another herbicidally active ingredient. In such a case, the ratio thereof can not generally be defined since it varies depending upon various conditions such as the types of compounds and plants to be controlled and further, weather and soil conditions, varieties of the crop plants, the timing for the application of the herbicide and the types of the formulations. Preferred examples of the ratio of the compound of the formula (I) and the other two herbicidal active ingredients are as follows.

Usually, (compound of the formula (I)):(B1):(benfuresate)=1:0.01 to 50:1 to 500, preferably 1:0.5 to 25:5 to 100.

Usually (compound of the formula (I)):(B1):(azimsulfuron)=1:0.01 to 50:0.005 to 1, preferably 1:0.5 to 25:0.05 to 0.95.

The application amount of the herbicidal composition of the present invention can not generally be defined since it varies depending upon various conditions such as the mix ratio of the compound of the formula (I) or its salt, and compound B, its salt or its alkyl ester as active ingredients, the formulation, weather conditions, the types and growth conditions of the plants to be controlled. As preferred examples, the compound of the formula (I) or its salt is usually from 0.001 to 50 g/a, preferably from 0.01 to 1 g/a compound B, its salt or its alkyl ester is usually from 0.001 to 50 g/a, preferably from 0.01 to 5 g/a, and the suitable total application amount thereof is usually from 0.002 to 75 g/a, preferably from 0.02 to 6 g/a.

Further, as mentioned above, the present invention includes a herbicidal composition containing, in addition to the compound of the formula (I) or its salt and compound B, its salt or its alkyl ester, another herbicidally active ingredient. In such a case, the application amount can not generally be defined since it varies depending upon various conditions such as the types of compounds and plants to be controlled and further, weather and soil conditions, varieties of the crop plants, the timing for the application of the herbicide and the types of the formulations. For example, the respective application amounts of the compound of the formula (I) and the other two herbicidally active ingredients and the suitable total application amount thereof are as follows.

In a case where the compound of the formula (I), (B1) and benfuresate are applied, the application amount of the compound of the formula (I) is usually from 0.001 to 50 g/a, preferably from 0.01 to 1 g/a, the application amount of (B1) is usually from 0.001 to 50 g/a, preferably from 0.01 to 5 g/a, the application amount of benfuresate is usually from 0.01 to 500 g/a, preferably from 0.1 to 20 g/a, and the suitable total application amount thereof is from 0.012 to 600 g/a, preferably from 0.12 to 26 g/a.

In a case where the compound of the formula (I), (B1) and azimsulfuron are applied, the application amount of the compound of the formula (I) is usually from 0.001 to 50 g/a, preferably from 0.01 to 1 g/a, the application amount of (B1) is usually from 0.001 to 50 g/a, preferably from 0.01 to 5 g/a, the application amount of azimsulfuron is usually from 0.0001 to 3 g/a, preferably from 0.001 to 0.3 g/a, and the suitable total application amount thereof is from 0.0021 to 103 g/a, preferably from 0.021 to 6.3 g/a.

The application amounts of the respective compounds at the respective applications can not generally be defined since they vary depending upon various conditions such as the types of the compounds and the plants to be controlled and further, weather and soil conditions, varieties of the crop plants, the timing for the application of the herbicide and the types of the formulations. Accordingly, the optimum ratio can be determined individually considering the above various conditions, etc., e.g. by suitably carrying out a preliminary test.

The present invention includes a method for controlling undesired plants or inhibiting their growth, which comprises applying the compound of the formula (I) and compound B in the respectively above-mentioned application amounts or applying them in the above-mentioned suitable total application amount. In the application, the application to the undesired plants or the application to a place where they grow (either before or after the emergence of the undesired plants) may optionally be selected.

The herbicidal composition of the present invention is capable of controlling a wide range of undesired plants such as annual weeds and perennial weeds, at a low dose. The undesired plants include grasses (or gramineae) such as barnyardgrass (Echinochloa crus-galli L., Echinochloa oryzicola vasing), crabgrass (Digitaria sanguinalis L.), greenfoxtail (Setaria viridis L.), giant foxtail (Setaria faberi Herrm.), goosegrass (Eleusine indica L.), wild oat (Avena fatua L.), johnsongrass (Sorghum halepense L.), quackgrass (Agropyron repens L.), alexandergrass (Brachiaria plantaginea), paragrass (Panicum purpurascens), sprangletop (Leptochloa chinensis), red sprangletop (Leptochloa panicea), annual bluegrass (Poa annua L.), black grass (Alopecurus myosuroides Huds.) and cholorado bluestem (Agropyron tsukushiense (Honda) Ohwi), sedges (or Cyperaceae) such as rice flatsedge (Cyperus iria L.), purple nutsedge (Cyperus rotundus L.), yellow nutsedge (Cyperus esculentus L.), Japanese bulrush (Scirpus juncoides), flatsedge (Cyperus serotinus), small-flower umbrellaplant (Cyperus difformis), slender spikerush (Eleocharis acicularis) and water chestnut (Eleocharis kuroguwai), alismataceae such as Japanese ribbon waparo (Sagittaria pygmaea), arrow-head (Sagittaria trifolia) and narrowleaf waterplantain (Alisma canaliculatum), pontederiaceae such as monochoria (Monochoria vaginalis) and monochoria species (Monochoria korsakowii), scrophulariaceae such as false pimpernel (Lindernia pyxidaria) and abunome (Dopatrium junceum), lythraceae such as toothcup (Rotala india) and red stem (Ammannia multiflora), and broad leaves such as velvetleaf (Abutilon theophrasti MEDIC.), tall morningglory (Ipomoea purpurea L.), common lambsquarters (Chenopodium album L.), prickly sida (Sida spinosa L.), common purslane (Portulaca oleracea L.), slender amaranth (Amaranthus viridis L.), redroot pigweed (Amaranthus retroflexus L.), sicklepod (Cassia obtusifolia L.), black nightshade (Solanum nigrum L.), pale smartweed (Polygonum lapathifolium L.), common chickweed (Stellaria media L.), common cocklebur (Xanthium strumarium L.), flexuous bittercress (Cardamine flexuosa WITH.), henbit (Lamium amplexicaule L.), common ragweed (Ambrosia elatior L.), catchweed (Galium spurium L.), field bindweed (Calystegia arvensis L.), jimsonweed (Datura stramonium), thistle (Breea setosa (BIEB.) KITAM.) and threeseeded copperleaf (Acalypha australis L.). Further, the herbicidal composition of the present invention is capable of providing good effects when applied at either stage of before or after the germination of the weeds.

The herbicidal composition of the present invention may take various application forms such as soil application, foliar application and water application and is useful for controlling undesired plants in agricultural fields such as upland fields, orchards or paddy fields, or non-agricultural fields such as levee, fallow field, play grounds, vacant grounds, forests, factory sites, railway sides or road sides.

Further, so long as the object of the present invention is met, the composition of the present invention may further contain another herbicidally active ingredient in addition to the above-described active ingredients, whereby it may sometimes be possible to improve e.g. the herbicidal activities, the timing for the application of the herbicide or the range of the weeds to be controlled. Such another herbicidally active ingredient includes, for example, the following compounds (common names including ones under application for approval by ISO, or developing codes). Even when not specifically mentioned here, in a case where such compounds have salts, alkyl esters, etc., they are, of course, all included.

(1) Those which are believed to exhibit herbicidal effects by disturbing hormone activities of plants, such as a phenoxy type such as 2,4-D, 2,4-DB, 2,4-DP, MCPA, MCPB, MCPP or naproanilide, an aromatic carboxylic acid type such as 2,3,6-TEA, dicamba, dichlobenil, picloram, trIclopyr, clopyralid or aminopyralid, and others such as naptalam, benazolin, quinclorac, quinmerac, diflufenzopyr and thiazopyr.

(2) Those which are believed to exhibit herbicidal effects by inhibiting photosynthesis of plants, such as a urea type such as chlorotoluron, diuron, fluometuron, linuron, isoproturon, metobenzuron or tebuthiuron, a triazine type such as simazine, atrazine, atratone, simetryn, prometryn, dimethametryn, hexazinone, metribuzin, terbuthylazine, cyanazine, ametryn, cybutryne, triaziflam or propazine, a uracil type such as bromacil, lenacil or terbacil, an anilide type such as propanil or cypromid, a carbamate type such as swep, desmedipham or phenmedipham, a hydroxybenzonitrile type such as bromoxynil, bromoxynil-octanoate or ioxynil, and others such as pyridate, bentazone, amicarbazone and methazole.

(3) Quaternary ammonium salt type such as paraquat or diquat, which is believed to be converted to free radicals by itself to form active oxygen in the plant body.

(4) Those which are believed to exhibit herbicidal effects by inhibiting chlorophyll biosynthesis of plants and abnormally accumulating a photosensitizing peroxide substance in the plant body, such as a diphenylether type such as nitrofen, chlomethoxyfen, bifenox, acifluorfen-sodium, fomesafen, oxyfluorfen, lactofen or ethoxyfen-ethyl, a cyclic imide type such as chlorphthalim, flumioxazin, flumiclorac-pentyl or fluthiacet-methyl, and others such as oxadiargyl, oxadiazon, sulfentrazone, thidiazimin, pentoxazone, azafenidin, isopropazole, pyraflufen-ethyl, benzfendizone, butafenacil, metobenzuron, cinidon-ethyl, flupoxam, fluazolate, profluazol, pyrachlonil and flufenpyr-ethyl.

(5) Those which are believed to exhibit herbicidal effects characterized by bleaching activities by inhibiting chromogenesis of plants such as carotenoids, such as a pyridazinone type such as norflurazon, chloridazon or metflurazon, a pyrazole type such as pyrazolate, pyrazoxyfen, benzofenap or BAS-670H, and others such as amitrol, fluridone, flurtamone, diflufenican, methoxyphenone, clomazone, sulcotrione, mesotrione, AVH-301, isoxaflutole, difenzoquat, isoxachlortole, benzobicyclon, picolinafen and beflubutamid.

(6) Those which exhibit strong herbicidal effects specifically to gramineous plants, such as an aryloxyphenoxypropionic acid type such as diclofop-methyl, flamprop-M-methyl, pyriphenop-sodium, fluazifop-butyl, haloxyfop-methyl, quizalofop-ethyl, cyhalofop-butyl, fenoxaprop-ethyl or metamifop-propyl, and a cyclohexanedione type such as alloxydim-sodium, clethodim, sethoxydim, tralkoxydim, butroxydim, tepraloxydim, caloxydim, clefoxydim or profoxydim.

(7) Those which are believed to exhibit herbicidal effects by inhibiting an amino acid biosynthesis of plants, such as a sulfonylurea type such as chlorimuron-ethyl, sulfometuron-methyl, primisulfuron-methyl, bensulfuron-methyl, chlorsulfuron, metsulfuron-methyl, cinosulfuron, pyrazosulfuron-ethyl, azimsulfuron, flazasulfuron, rimsulfuron, nicosulfuron, imazosulfuron, cyclosulfamuron, prosulfuron, flupyrsulfuron, trisulfuron-methyl, halosulfuron-methyl, thifensulfuron-methyl, ethoxysulfuron, oxasulfuron, ethametsulfuron, flupyrsulfuron, iodosulfuron, sulfosulfuron, triasulfuron, tribenuron-methyl, tri-tosulfuron, foramsulfuron, trifloxysulfuron, isosulfuron-methyl or mesosulfuron-methyl, a triazolopyrimidinesulfonamide type such as flumetsulam, metosulam, diclosulam, cloransulam-methyl, florasulam, metosulfam or penoxsulam, an imidazolinone type such as imazapyr, imazethapyr, imazaquin, imazamox, irmazameth, imazamethabenz or imazapic, a pyrimidinylsalicylic acid type such as pyrithiobac-sodium, bispyribac-sodium, pyriminobac-methyl, pyribenzoxim, pyriftalid or KUH-021, a sulfonylaminocarbonyltriazolinone type such as flucarbazone or procarbazone-sodium, and others such as glyphosate, glyphosate-ammonium, glyphosate-isopropylamine, sulfosate, glufosinate, glufosinate-ammonium and bilanafos.

(8) Those which are believed to exhibit herbicidal effects by inhibiting cell mitoses of plants, such as a dinitroaniline type such as trifluralin, oryzalin, nitralin, pendimethalin, ethalfluralin, benfluralin or prodiamine, an amide type such as bensulide, napronamide or pronamide, an organic phosphorus type such as amiprofos-methyl, butamifos, anilofos or piperophos, a phenylcarbamate type such as propham, chlorpropham or barban, a cumylamine type such as daimuron, cumyluron or bromobutide, and others such as asulam, dithiopyr and thiazopyr.

(9) Those which are believed to exhibit herbicidal effects by inhibiting protein biosynthesis or lipid biosynthesis of plants, such as a chloroacetamide type such as alachlor, metazachlor, butachlor, pretilachlor, metolachlor, S-metolachlor, thenylchlor, pethoxamid, acetochlor, propachlor or propisochlor, a carbamate type such as dimepiperate, molinate or pyributicarb, and others such as etobenzanid, mefenacet, flufenacet, tridiphane, cafenstrole, fentrazamide, oxaziclomefone, indanofan dimethenamid and benfuresate.

(10) A thiocarbamate type such as EPTC, butylate, vernolate, pebulate, cycloate, prosulfocarb, esprocarb, thiobencarb, diallate or triallate, and others such as MSMA, DSMA, endothall, ethofumesate, sodium chlorate, pelargonic acid, fosamine, pinoxadern and HOK-201.

(11) Those which are believed to exhibit herbicidal effects by being parasitic on plants, such as Xanthomonas campestris, Epicoccosurus nematosurus, Exserohilum monoseras and Drechsrela monoceras.

The herbicidal composition of the present invention may be prepared by mixing the compound of the formula (I) or its salt, and compound B, its salt or its alkyl ester, as active ingredients, with various additives in accordance with conventional formulation methods for agricultural chemicals, and applied in the form of various formulations such as dusts, granules, water dispersible granules, wettable powders, tablets, pills, capsules (including a formulation packaged by a water soluble film), water-based suspensions oil-based suspensions, microemulsions, suspoemulsions, water soluble powders, emulsifiable concentrates, soluble concentrates or pastes. It may be formed into any formulation which is commonly used in this field, so long as the object of the present invention is thereby met.

At the time of the formulation, the compound of the formula (I) or its salt and compound B, its salt or its alkyl ester may be mixed together for the formulation, or they may be separately formulated and mixed together at the time of the application.

The additives to be used for the formulation include, for example, a solid carrier such as diatomaceous earth, slaked lime, calcium carbonate, talc, white carbon, kaoline, bentonite, kaolinite, a mixture of sericite, clay, sodium carbonate, sodium bicarbonate, mirabllite, zeolite or starch; a solvent such as water, toluene, xylene, solvent naphtha, dioxane, acetone, isophorone, methyl isobutyl ketone, chlorobenzene, cyclohexane, dimethyl sulfoxide, N,N-dimethylformamide, dimethylacetamide, N-methyl-2-pyrrolidone or an alcohol; an anionic surfactant such as a salt of fatty acid, a benzoate, a polycarboxylate, a salt of alkylsulfuric acid ester, an alkyl sulfate, an alkylaryl sulfate, an alkyl diglycol ether sulfate, a salt of alcohol sulfuric acid ester, an alkyl sulfonate, an alkylaryl sulfonate, an aryl sulfonate, a lignin sulfonate, an alkyldiphenyl ether disulfonate, a polystyrene sulfonate, a salt of alkylphosphoric acid ester, an alkylaryl phosphate, a styrylaryl phosphate, a salt of polyoxyethylene alkyl ether sulfuric acid ester, a polyoxyethylene alkylaryl ether sulfate, a salt of polyoxyethylene alkylaryl ether sulfuric acid ester, a polyoxyethylene alkyl ether phosphate, a salt of polyoxyethylene alkylaryl phosphoric acid ester, a salt of polyoxyethylene aryl ether phosphoric acid ester, a naphthalene sulfonic acid condensed with formaldehyde or an alkylnaphthalene sulfonate condensed with formaldehyde; a nonionic surfactant such as a sorbitan fatty acid ester, a glycerin fatty acid ester, a fatty acid polyglyceride, a fatty acid alcohol polyglycol ether, acetylene glycol, acetylene alcohol, an oxyalkylene block polymer, a polyoxyethylene alkyl ether, a polyoxyethylene alkylaryl ether, a polyoxyethylene styrylaryl ether, a polyoxyethylene glycol alkyl ether, polyethylene glycol, a polyoxyethylene fatty acid ester, a polyoxyethylene sorbitan fatty acid ester, a polyoxyethylene glycerin fatty acid ester, a polyoxyethylene hydrogenated castor oil or a polyoxypropylene fatty acid ester; and a vegetable oil or mineral oil such as olive oil, kapok oil, castor oil, palm oil, camellia oil, coconut oil, sesame oil corn oil, rice bran oil, peanut oil, cottonseed oil soybean oil, rapeseed oil, linseed oil, tung oil or liquid paraffins. These additives may suitably selected for use alone or in combination as a mixture of two or more of them, so long as the object of the present invention is met. Further, additives other than the above-mentioned may be suitably selected for use among those known in this field. For example, various additives commonly used, such as a filler, a thickener, an anti-settling agent, an anti-freezing agent, a dispersion stabilizer, a safener, an anti-mold agent, a bubble agent, a disintegrator and a binder, may be used. The mix ratio by weight of the active ingredients to such various additives in the herbicidal composition of the present invention may be from 0.001-99.999 to 95:5, preferably from 0.005:99.995 to 90:10.

As a method for applying the herbicidal composition of the present invention, various methods may be employed and may suitably be selected for use depending upon various conditions such as the application sites, the formulations, the types or growth conditions of the plants to be controlled. For example, the following methods 1 to 5 may be mentioned.
1. The compound of the formula (I) or its salt, and compound B, its salt or its alkyl ester are mixed together to prepare a formulation, which is applied as it is.
2. The compound of the formula (I) or its salt, and compound B, its salt or its alkyl ester are mixed together to prepare a formulation which is diluted to a predetermined concentration with e.g. water, and, if necessary, various additives (a surfactant, a vegetable oil, a mineral oil, etc.) are added, followed by the application
3. The compound of the formula (I) or its salt, and compound B, its salt or its alkyl ester are separately formulated and applied as formulated.
4. The compound of the formula (I) or its salt, and compound B, its salt or its alkyl ester are separately formulated and respectively diluted to the predetermined concentrations with e.g. water and, if necessary, various additives (a surfactant, a vegetable oil, a mineral oil, etc.) are added, followed by the application.
5. The compound of the formula (I) or its salt, and compound B, its salt or its alkyl ester are separately formulated and then mixed at the time of diluting them to the predetermined concentrations with e.g. water, and if necessary, various additives (a surfactant, a vegetable oil, a mineral oil, etc.) are added, followed by the application.

### EXAMPLES

Now, Formulation Examples for the herbicidal composition of the present invention will be described, but the present invention is by no means restricted thereto.

### Formulation Example 1

| | | | |
|---|---|---|---|
| (1) | Compound A2 | 10.15 | g |
| (2) | Compound B1 | 16.50 | g |
| (3) | Sodium naphthalene sulfonate condensed with | 3.00 | g |
| | formaldehyde (trade name: Lavelin FA-N, manufac- | | |
| | tured by DAI-ICHI KOGYO SEIYAKU CO., LTD.) | | |
| (4) | Sodium dialkyinaphthalene sulfonate (trade name: | 3.00 | g |
| | Newkalgen BX-C, manufactured by TAKEMOTO OIL | | |
| | & FAT CO., LTD.) | | |
| (5) | White carbon | 10.00 | g |
| (6) | Kaoline | 57.35 | g |

Compound B1 is heated at 60° C. and mixed with white carbon, and the other components are mixed to obtain a wettable powder.

### Formulation Example 2

| | | | |
|---|---|---|---|
| (1) | Compound A2 | 10.15 | g |
| (2) | Compound B1 | 16.50 | g |
| (3) | Sodium naphthalene sulfonate condensed with | 5.00 | g |
| | formaldehyde (trade name: Newkalgen WG-2, manu- | | |
| | factured by TAKEMOTO OIL & FAT CO., LTD.) | | |
| (4) | Sodium alkylnaphthalene sulfonate (trade name: | 3.00 | g |
| | Newkalgen WG-1, manufactured by TAKEMOTO OIL | | |
| | & FAT CO., LTD.) | | |
| (5) | White carbon | 10.00 | g |
| (6) | Starch | 15.00 | g |
| (7) | Calcium carbonate | 40.35 | g |

Compound B1 is heated at 60° C. and mixed with white carbon, and the other components are mixed, and then the mixture is kneaded with water. The kneaded product is granulated with an extruder equipped with a screen having a diameter of 0.8 mm and dried for 30 minutes by a fluidized bed dryer set at 60° C. and then sieved (to from 14 to 60 mesh) to obtain water dispersible granules.

### Formulation Example 3

| | | |
|---|---|---|
| (1) Bentonite containing 10 wt % of compound A2 | 2.03 | g |
| (2) Bentonite containing 10 wt % of compound B1 | 3.30 | g |
| (3) Newkalgen BX-C (trade name) | 3.00 | g |
| (4) Newkalgen WG-1 (trade name) | 3.00 | g |
| (5) Bentonite | 30.00 | g |
| (6) Calcium carbonate | 58.67 | g |

The above components are mixed and kneaded with water. The kneaded product is granulated with an extruder equipped with a screen having a diameter of 0.8 mm and dried for 30 minutes by a fluidized bed dryer set at 60° C. and then sieved (to from 14 to 60 mesh) to obtain granules.

### Formulation Example 4

| | | | |
|---|---|---|---|
| (1) | Compound A2 | 6.09 | g |
| (2) | Compound B1 | 9.90 | g |
| (3) | Salt of polyoxyethylene aryl ether phosphoric | 3.00 | g |
| | acid ester (trade name: Soprophor FLK/70, manu- | | |
| | factured by Rhodia Nicca, Ltd.) | | |
| (4) | Sodium methylnaphthalene sulfonate condensed | 3.00 | g |
| | with formaldehyde (trade name: Supragil MNS/90, | | |
| | manufactured by Rhodia Nicca, Ltd.) | | |
| (5) | Xanthan gum | 0.50 | g |
| (6) | Propylene glycol | 10.00 | g |
| (7) | Water | 67.51 | g |

Text

The above components are mixed and subjected to wet milling to obtain a suspoemulsion.

### Formulation Example 5

| | | | |
|---|---|---|---|
| (1) | Compound A2 (purity 98.4%) | 0.75 | g |
| (2) | Compound B1 (purity 91.2%) | 2.19 | g |
| (3) | Benfuresate (purity 97.0%) | 20.62 | g |
| (4) | Polyoxyethylene styrylphenyl ether and calcium | 15.00 | g |
| | dodecylbenzene sulfonate (trade name; Sorpol 3661S, | | |
| | manufactured by TOHO Chemical Industry Co., Ltd.) | | |
| (5) | Aromatic hydrocarbon (trade name: Solvesso 150, | 36.44 | g |
| | manuractured by EXXON CHEMICAL) | | |
| (6) | N-Methyl-2-pyrrolidone | 25.00 | g |

Compound A2, compound B1 and benfuresate are dissolved in N-methyl-2-pyrrolidone at room temperature, and then Solvesso 150 and Sorpol 3661S are mixed in the above mix ratio to obtain an emulsifiable concentrate.

### Formulation Example 6

| | | | |
|---|---|---|---|
| (1) | Compound A2 (purity 98.4%) | 0.75 | g |
| (2) | Compound B1 (purity 91.2%) | 3 29 | g |
| (3) | Benfuresate (purity 97.0%) | 20.62 | g |
| (4) | Polyoxyethylene styrylphenyl ether and calcium | 15.00 | g |
| | dodecylbenzene sulfonate (trade name: Sorpol 3661S, | | |
| | manufactured by TOHO Chemical Industry Co., Ltd.) | | |
| (5) | Aromatic hydrocarbon (trade name: Solvesso 150, | 35.34 | g |
| | manufactured by EXXON CHEMICAL) | | |
| (6) | N-Methyl-2-pyrrolidone | 25.00 | g |

Compound A2, compound B1 and benfuresate are dissolved in N-methyl-2-pyrrolidone at room temperature, and then Solvesso 150 and Sorpol 3661S are mixed in the above mix ratio to obtain an emulsifiable concentrate.

### Formulation Example 7

| | | | |
|---|---|---|---|
| (1) | Compound A2 (purity 98.4%) | 2.24 | g |
| (2) | Compound B1 (purity 91.2%) | 6.58 | g |
| (3) | Azimsulfuron (purity 99.0%) | 0.61 | g |
| (4) | Sodium naphthalene sulfonate condensed with | 3.00 | g |
| | formaldehyde (trade name: Lavelin FA-N, manu- | | |
| | factured by DAI-ICHI KOGYO SEIYAKU CO., LTD.) | | |
| (5) | Sodium dialkylnaphthalene sulfonate (trade name: | 3.00 | g |
| | NK.BX-C, manufactured by TAKEMOTO OIL & | | |
| | FAT CO., LTD.) | | |
| (6) | White carbon (trade name: Carplex #80, | 4.00 | g |
| | manufactured by DSL Japan Co., Ltd.) | | |
| (7) | Clay | 80.57 | g |

Compound B1 is heated at 60° C. and mixed with white carbon, and the other components are mixed in the above mix ratio, and the mixture is pulverized by a centrifugal mill (a screen with a diameter of 1.0 mm), to obtain a wettable powder.

### Formulation Example 8

| | | | |
|---|---|---|---|
| (1) | Compound A2 (purity 98.4%) | 2.24 | g |
| (2) | Compound B1 (purity 91.2%) | 9.87 | g |
| (3) | Azimsulfuron (purity 99.0%) | 1.01 | g |
| (4) | Sodium naphthalene sulfonate condensed with | 3.00 | g |
| | formaldehyde (trade name: Lavelin FA-N, manu- | | |
| | factured by DAI-ICHI KOGYO SEIYAKU CO., LTD.) | | |
| (5) | Sodium dialkylnaphthalene sulfonate (trade name: | 3.00 | g |
| | NK.BX-C, manufactured by DSL Japan Co., Ltd.) | | |
| (6) | White carbon (trade name: Carplex #80, | 6.00 | g |
| | manufactured by DSL Japan Co., Ltd.) | | |
| (7) | Clay | 74.88 | g |

Compound B1 is heated at 60° C. and mixed with white carbon and the other components are mixed in the above mix ratio, and the mixture is pulverized by a centrifugal mill (a screen with a diameter of 1.0 mm) to obtain a wettable powder.

### Formulation Example 9

| | | | |
|---|---|---|---|
| (1) | Compound A1 (purity 98.4%) | 0.75 | g |
| (2) | Compound B1 (purity 91.2%) | 2.19 | g |
| (3) | Benfuresate (purity 97.0%) | 20.62 | g |
| (4) | Polyoxyethylene styrylphenyl ether and calcium | 15.00 | g |
| | dodecylbenzene sulfonate (trade name Sorpol 2661S, | | |
| | manufactured by TOHO Chemical Industry Co., Ltd.) | | |
| (5) | Aromatic hydrocarbon (trade name: Solvesso 150, | 36.44 | g |
| | manufactured by EXXON CHEMICAL) | | |
| (6) | N-Methyl-2-pyrrolidone | 25.00 | g |

Compound A1, compound B1 and benfuresate are dissolved in N-methyl-2-pyrrolidone at room temperature, and then Solvesso 150 and Sorpol 3661S are mixed in the above mix ratio to obtain an emulsifiable concentrate.

### Formulation Example 10

| | | | |
|---|---|---|---|
| (1) | Compound A1 (purity 98.4%) | 0.75 | g |
| (2) | Compound B1 (purity 91.2%) | 3.29 | g |
| (3) | Benfuresate (purity 97.0%) | 20.62 | g |
| (4) | Polyoxyethylene styrylphenyl ether and calcium | 15.00 | g |
| | dodecylbenzene sulfonate (trade name: Sorpol 3661S, | | |
| | manufactured by TOHO Chemical Industry Co., Ltd.) | | |
| (5) | Aromatic hydrocarbon (trade name: Solvesso 150, | 35.34 | g |
| | manufactured by EXXON CHEMICAL) | | |
| (6) | N-Methyl-2-pyrrolidone | 25.00 | g |

dissolved in N-methyl-2-pyrrolidone at room temperature, and then Solvesso 150 and Sorpol 3661S are mixed in the above mix ratio to obtain an emulsifiable concentrate.

### Formulation Example 11

| | | | |
|---|---|---|---|
| (1) | Compound A1 (purity 98.4%) | 2.24 | g |
| (2) | Compound B1 (purity 91.2%) | 6.58 | g |
| (3) | Azimsulfuron (purity 99.0%) | 0.61 | g |
| (4) | Sodium naphthalene sulfonate condensed with | 3.00 | g |
| | formaldehyde (trade name: Lavelin FA-N manu- | | |
| | factured by DAI-ICHI KOGYO SEIYAKU CO., LTD.) | | |
| (5) | Sodium dialkylnaphthalene sulfonate (trade name: | 3.00 | g |
| | NK.BX-C, manufactured by TAKEMOTO OIL & | | |
| | FAT CO., LTD.) | | |
| (6) | White carbon (trade name: Carplex #80, | 4.00 | g |
| | manufactured by DSL Japan Co., Ltd.) | | |
| (7) | Clay | 80.57 | g |

Compound B1 is heated at 60° C. and mixed with white carbon, and the other components are mixed in the above mix ratio, and the mixture is pulverized by a centrifugal mill (a screen with a diameter of 1.0 mm) to obtain a wettable powder.

### Formulation Example 12

| | | | |
|---|---|---|---|
| (1) | Compound A1 (purity 98.4%) | 2.24 | g |
| (2) | Compound B1 (purity 91.2%) | 9.87 | g |
| (3) | Azimsulfuron (purity 99.0%) | 1.01 | g |
| (4) | Sodium naphthalene sulfonate condensed with | 3.00 | g |
| | formaldehyde (trade name: Lavelin FA-N, manu- | | |
| | factured by DAI-ICHI KOGYO SEIYAKU CO., LTD.) | | |
| (5) | Sodium dialkylnaphthalene sulfonate (trade name: | 3.00 | g |
| | NK.BX-C manufactured by TAKEMOTO OIL & | | |
| | FAT CO., LTD.) | | |
| (6) | White carbon (trade Carplex #80, | 6.00 | g |
| | manufactured by DSL Japan Co., Ltd.) | | |
| (7) | Clay | 74.88 | g |

Compound B1 is heated at 60° C. and mixed with white carbon, and the other components are mixed in the above mix ratio, and the mixture is pulverized by a centrifugal mill (a screen with a diameter of 1.0 mm) to obtain a wettable powder.

Now, Test Examples For the herbicidal composition of the present invention will be described.

### Test Example 1

Paddy field soil was put into a 1/1,700 are pot, and seeds of barnyardgrass (Echinochloa oryzicola vasing) were sown and left to stand under an irrigated condition with a water depth of 3.5 cm. On the next day after the sowing, a wettable powder of compound A2 diluted with water and a microemulsion of compound B1 as it was were, respectively, applied under submerged condition so that the active ingredients became the prescribed amounts, respectively The state of growth was visually observed 21 days after application and the growth inhibition rate (%) evaluated in accordance with the following evaluation standard (observed value) and the growth inhibition rate (%) calculated by the above-mentioned Colby method (expected value) are shown in Table 1.

Growth inhibition rate (%)=0% (equivalent to the non-treated area) to 100% (complete kill)

TABLE 1

| | |
|---|---|
| Amount of application | Growth inhibition rate |
| of active ingredients | (%) |

| Compounds | (g/a) | Observed | Expected |
|---|---|---|---|
| A2 | 0.2 | 98 | — |
| | 0.1 | 95 | — |
| B1 | 0.3 | 0 | — |
| | 0.2 | 0 | — |
| A2 + B1 | 0.2 + 0.3 | 100 | 98 |
| | 0.2 + 0.2 | 100 | 98 |
| | 0.1 + 0.3 | 100 | 95 |
| | 0.1 + 0.2 | 100 | 95 |

### Test Example 2

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2 leaf stage, a wettable powder of compound A2 diluted with water and a microemulsion of compound B1 as it was were, respectively, applied under submerged condition so that the active ingredients became the prescribed amounts, respectively. The state of growth was visually observed 18 days after application and evaluated in the same manner as in the above Test Example 1. The results are shown in Table 2.

TABLE 2

| | Amount of application | Growth Inhibition rate | |
|---|---|---|---|
| | of active ingredients | (%) | |
| Compounds | (g/a) | Observed | Expected |
| A2 | 0.15 | 99 | — |
| | 0.10 | 98 | — |
| | 0.05 | 84 | — |
| B1 | 1.012 | 18 | — |
| | 0.675 | 13 | — |
| | 0.450 | 8 | — |
| | 0.300 | 3 | — |
| A2 + B1 | 0.15 + 1.012 | 100 | 99 |
| | 0.15 + 0.675 | 100 | 99 |
| | 0.15 + 0.450 | 100 | 99 |
| | 0.10 + 1.012 | 99 | 98 |
| | 0.10 + 0.675 | 99 | 98 |
| | 0.10 + 0.450 | 99 | 98 |
| | 0.10 + 0.300 | 99 | 98 |
| | 0.05 + 1.012 | 97 | 87 |
| | 0.05 + 0.675 | 90 | 86 |

### Test Example 3

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 3 leaf stage, wettable powders of compound A1 and compound B1 were, respectively, diluted with water and applied under submerged condition so that the active ingredients became the prescribed amounts, respectively. The state of growth was visually observed 21 days after application and evaluated in the same manner as in the above Test Example 1. The results are shown in Table 3.

TABLE 3

| | |
|---|---|
| Amount of application | Growth inhibition rate |
| of active ingredients | (%) |

| Compounds | (g/a) | Observed | Expected |
|---|---|---|---|
| A1 | 0.165 | 98 | — |
| | 0.11 | 97 | — |
| | 0.083 | 83 | — |
| B1 | 0.225 | 0 | — |
| | 0.113 | 0 | — |
| A1 + B1 | 0.165 + 0.225 | 100 | 98 |
| | 0.165 + 0.113 | 100 | 98 |
| | 0.11 + 0.225 | 100 | 97 |
| | 0.11 + 0.113 | 100 | 97 |
| | 0.083 + 0.225 | 99 | 83 |
| | 0.083 + 0.113 | 90 | 83 |

### Test Example 4

Paddy field soil was put into a 1/1,700 are pot, and seeds of Japanese bulrush (Scirpus juncoides) were sown and left to stand under an irrigated condition with a water depth of 3.5 cm. When Japanese bulrush reached 2.2 to 2.8 leaf stage, a wettable powder of compound A2, a wettable powder of compound B1 and an emulsifiable concentrate of benfuresate were, respectively, diluted with water and applied under submerged condition so that the active ingredients became the prescribed amounts, respectively. The state of growth was visually observed 29 days after application and evaluated in the same manner as in the above Test Example 1. The results are shown in Table 4.

TABLE 4

| | Amount of application | Growth inhibition rate |
|---|---|---|
| | of active ingredients | (%) |
| Compounds | (g/a) | Observed |
| A2 | 0.22 | 87 |
| Benfuresate | 9 | 89 |
| | 6 | 90 |
| B1 | 1.5 | 99 |
| | 1 | 100 |
| | 0.5 | 80 |
| A2 + | 0.22 + 9 + 1.5 | 100 |
| benfuresate + | 0.22 + 9 + 1 | 100 |
| B1 | 0.22 + 9 + 0.5 | 98 |
| | 0.22 + 6 + 1.5 | 100 |
| | 0.22 + 6 + 1 | 99 |
| | 0.22 + 6 + 0.5 | 99 |

### Test Example 5

Paddy field soil was put into a 1/10,000 are pot, and seeds of barnyardgrass (Echinochloa oryzicola vasing) were sown and left to stand under an irrigated condition with a water depth of 3.5 cm. When barnyardgrass reached 2.4 to 3.2 leaf stage, wettable powders of compound A2 compound B1 and azimsulfuron were, respectively, diluted with water and applied under submerged condition so that the active ingredients became the prescribed amounts, respectively. The state of growth was visually observed 29 days after application and evaluated in the same manner as in the above Test Example 1. The results are shown in Table 5.

TABLE 5

| | Amount of application | Growth inhibition rate |
|---|---|---|
| | of active ingredients | (%) |
| Compounds | (g/a) | Observed |
| A2 | 0.11 | 96 |
| Azimsulfuron | 0.075 | 60 |
| | 0.06 | 57 |
| B1 | 0.375 | 5 |
| A2 + | 0.11 + 0.075 + 0.375 | 97 |
| azimsulfuron + | 0.11 + 0.06 + 0.375 | 97 |
| B1 | | |

### INDUSTRIAL APPLICABILITY

The herbicidal composition of the present invention is capable of controlling a wide range of weeds emerging in cropland or non-crop land, since it has a wider herbicidal spectrum is highly active and has a long lasting effect.

The entire disclosures of Japanese Patent Application No. 2004-271282 filed on Sep. 17, 2004 and Japanese Patent Application No. 2005-057621 filed on Mar. 2, 2005 including specifications, claims and summaries are incorporated herein by reference in their entireties.

1. A herbicidal composition comprising (1) a compound of the following formula (I) or its salt: 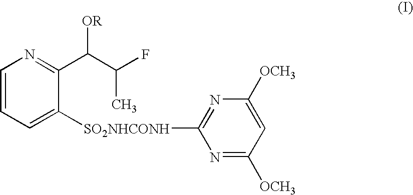
wherein R is a hydrogen atom or —COCH₂OCH₃, and (2) 2-chloro-3-[2-chloro-5-(4-difluoromethyl-4,5-dihydro-3-methyl-5-oxo-1H-1,2,4-triazol-1-yl)-4-fluorophenyl]propionic acid, its salt or its alkyl ester, as active ingredients.

2. The herbicidal composition according to claim 1, which contains from 0.01 to 50 parts by weight of the compound (2), its salt or its alkyl ester per part by weight of the compound (1) or its salt.

3. The herbicidal composition according to claim 1, which further contains another herbicidally active ingredient.

4. A method for controlling undesired plants or inhibiting their growth, which comprises applying a herbicidally effective amount of the herbicidal composition as defined in claim 1.

5. A method for controlling undesired plants or inhibiting their growth, which comprises applying a herbicidally effective amount of the herbicidal composition as defined in claim 3.

6. A method for controlling undesired plants or inhibiting their growth which comprises applying a herbicidally effective amount of the compound (1) or its salt and a herbicidally effective amount of the compound (2), its salt or its alkyl ester, as defined in claim 1.

7. A method for controlling undesired plants or inhibiting their growth, which comprises applying a herbicidally effective amount of the compound (1) or its salt and a herbicidally effective amount of the compound (2), its salt or its alkyl ester, as defined in claim 1, and a herbicidally effective amount of another is herbicidally active ingredient.
